(19) United States
(12) Patent Application Publication
(10) Pub. No.: US 2005/0161895 A1
(43) Pub. Date: Jul. 28, 2005

(54) Scooter

(76) Inventor: Michael Roydon Puzey, Malanshof (ZA)

Correspondence Address: BACON & THOMAS, PLLC, 625 SLATERS LANE, FOURTH FLOOR, ALEXANDRIA, VA, 22314, US

(21) Appl. No.: 10/765,150

(22) Filed: Jan. 28, 2004

(51) Int. Cl. B62M 1/00

(52) U.S. Cl. 280/87.05

(57) ABSTRACT

A scooter which includes a base, front and rear wheels near respective opposed ends of the base, an upwardly extending support, a seat at an upper end of the support, structure, at a lower end of the support, which includes at least first and second relatively moveable formations which are respectively engageable with third and fourth formations on the base, and an actuator for causing relative movement of the first and second formations thereby to secure the structure to the base.

### BACKGROUND OF THE INVENTION

This invention relates to a scooter which, in this specification, is intended to include a multi-wheeled device, whether of two, or more, wheels.

Small scooters which may be driven by petrol engines or electric motors currently enjoy widespread popularity. Some of these scooters are designed to include seats to facilitate user comfort. A practical problem which arises however when a scooter has a seat is that the space required for storing the scooter is increased.

### SUMMARY OF INVENTION

The invention provides a scooter which includes a base, front and rear wheels near respective opposed ends of the base, an upwardly extending support, a seat at an upper end of the support, structure, at a lower end of the support, which includes at least first and second relatively movable formations which are respectively engageable with third and fourth formations on the base, and an actuator for causing relative movement of the first and second formations thereby to secure the structure to the base.

The actuator may be provided on one or more of the base, a suitable part of the structure, and the support.

Preferably the first and second relatively movable formations are respectively first and second hook-shaped formations which are respectively engageable with the third and fourth formations on the base.

In one form of the invention the third and fourth formations on the base are respective apertures with which the hook-shaped formations are respectively engageable.

Preferably the structure includes a locking member which is pivotally mounted to the support and which includes the first relatively movable formation, and a second member which includes the second relatively movable formation.

The actuator may be operable to cause the locking member to pivot relatively to the support and to the second member.

The actuator may be of any suitable kind. It may for example be a pressure lever, eg. of an over-centre design so that, when pressed down, it causes the locking member to engage securely with the base.

Preferably, though, the actuator includes a screw device which is threadedly engaged with at least one of the locking member and the support.

According to a different aspect of the invention there is provided a scooter which includes a base, front and rear wheels near respective opposed ends of the base, an upwardly extending support, a seat at an upper end of the support, a load transferring structure, at a lower end of the support, which bears against an upper surface of the base, at least two spaced formations on the load transferring structure which are respectively engageable with two complementary formations on the base, a locking member which is mounted for movement relatively to the support and which has at least one formation which is engageable with a complementary formation on the base, and an actuator for causing movement of the locking member relatively to the support thereby to secure the locking member and the load transferring structure to the base.

Preferably the load transferring structure includes a plate which bears on the upper surface of the base and the two spaced formations are hook-shaped formations on the plate, and the two complementary formations on the base are two respective apertures.

The invention also provides a scooter which includes a base, front and rear wheels near respective opposed ends of the base, an upwardly extending support, a seat at an upper end of the support, two webs which are fixed to a lower end of the support, a plate which is fixed to the webs and which bears on an upper surface of the base, the plate having two spaced hook-shaped formations which are respectively engageable with apertures in the base, a locking member which is pivotally secured to the base and which is engageable with a complementary formation on the base, and an actuator which is operable to move the locking member relatively to the plate thereby to secure the plate and the locking member to the base.

In a variation the plate is formed with holes and the base has hook-shaped formations which are engageable therewith. Similarly the locking member may have a hole which is engageable with a suitable formation on the base.

### BRIEF DESCRIPTION OF THE DRAWINGS

The invention is further described by way of examples with reference to the accompanying drawings in which:

FIG. 1 is a side view of a scooter which includes a seat arrangement according to the invention;

FIG. 2 is a side view of a lower end of the seat arrangement shown in FIG. 1;

FIGS. 3 and 4 are perspective views from the front and rear respectively of the lower end of the seat arrangement, as shown in FIG. 2, engaged with a base of the scooter; and

FIGS. 5 to 8 respectively illustrate possible variations of the invention.

### DESCRIPTION OF PREFERRED EMBODIMENTS

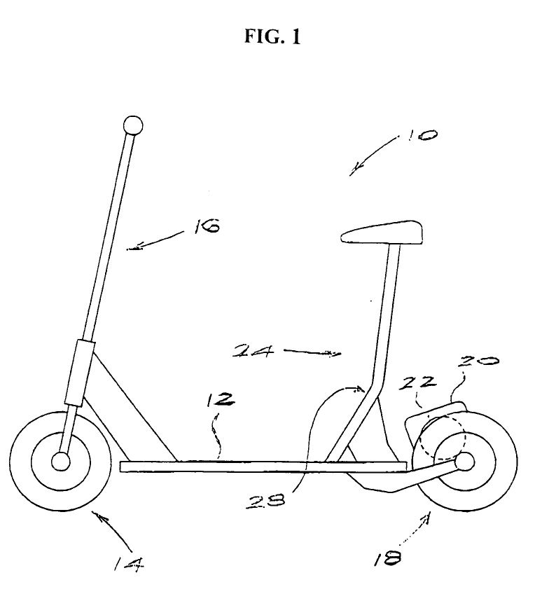

FIG. 1 of the accompanying drawings illustrates a scooter 10, according to the invention, which includes an elongate base or chassis 12, a front wheel 14, a steering arrangement 16 fixed to the front wheel, a rear wheel 18, an engine 20 for driving the rear wheel through a suitable drive arrangement or gear box 22, and a seat arrangement 24, near a rear end of the scooter, which extends upwardly from the base.

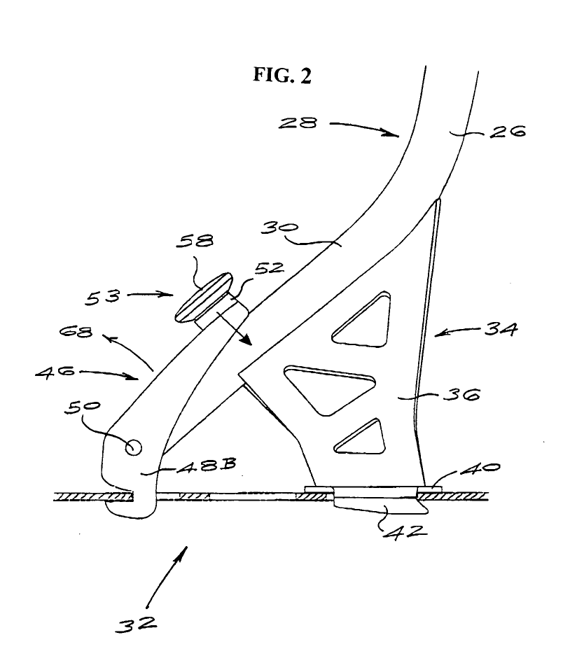

The seat arrangement 24, as is shown in further detail in FIGS. 2, 3 and 4, includes an upwardly extending support 26, which is formed from a length of pipe which has a bend 28 at a lower end. The bend defines a forwardly extending section 30, and load transferring structure 32 is fixed to a lower end of this section.

The load transferring structure 32 includes a brace component 34 formed from two outwardly extending braces or webs 36 and 38 respectively and a transverse plate 40 which is fixed to lower ends of the webs 36 and 38 and which includes hook-shaped formations 42 and 44 respectively at opposed ends.

A locking member 46 which includes components 48A and 48B respectively are located on opposing sides of the section 30 and are pivotally engaged therewith by means of a rod 50 which passes through registering holes which are formed in the components and in the section. A bridging piece 52 extends between upper ends of the hook-shaped components 48A and 48B. An actuator 53 in the form of a bolt 54 passes through a hole in the bridging piece and is threadedly engaged with a nut 56 which is fixed to the section 30. The bolt is rotatable in either direction, according to requirement, by means of a knob 58 secured to an outer projecting end of the bolt.

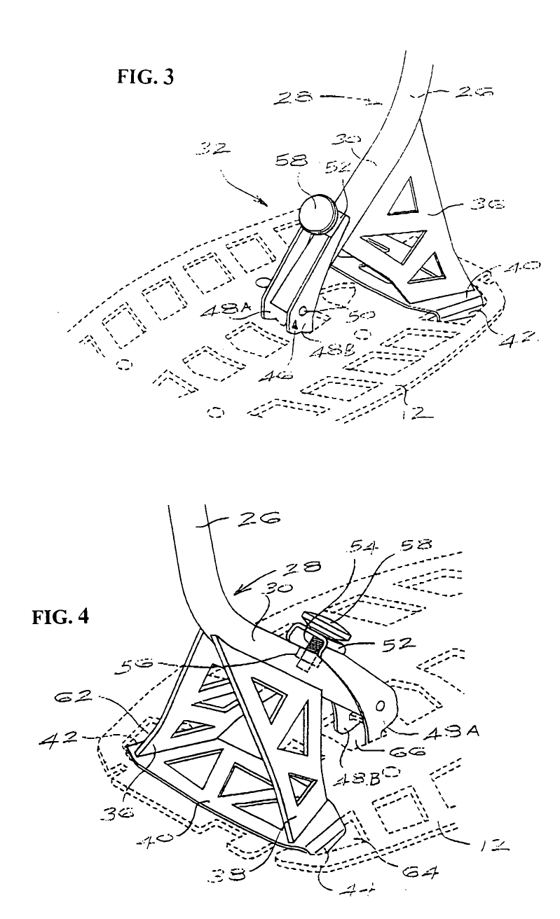

As is evident from FIGS. 3 and 4 the base or chassis 12 of the scooter, in this example, is formed from a sheet material with a plurality of apertures. The hook-shaped formations 42 and 44 on the plate 40 can be inserted into respective apertures 62 and 64. The hook-shaped components 48A and 48B are engageable with a single aperture 66 when the bolt 54 is loosened in a direction which allows limited movement of upper ends of the hook-shaped components in a direction 68, which is away from the section 30, see FIG. 2. If the bolt is tightened by rotating the knob 58 then the degree of relative movement is restricted and is for practical purposes eliminated thereby ensuring the various formations 42, 44, 48A and 48B remain engaged respectively with the apertures 62, 64 and 66.

The seat arrangement is readily attached to the base 12, or detached from the base, when required, simply by rotating the bolt 54 in one direction or in an opposing direction. The plate 40 and the divergent webs 36 and 38, together with the forwardly extending section 30, impart a distributed load-transferring arrangement from the support 26 to the base. The result is that the seat arrangement is rigidly attached to the base and there is no lost motion between the base and the support 26.

FIGS. 5 to 8 illustrate possible variations to the principles described thus far.

FIG. 5 is a cross sectional side view of a modified base 12A and a modified structure 32A. The plate 40 is replaced by a plate 40A with holes, only one of which marked 44A is visibly, instead of the hook-shaped formations 42 and 44. Conversely the base has hook-shaped formations, again only one of which marked 64A is shown in place of the apertures 62 and 64. The locking member 46A is similarly modified in that each of the components 48A and 48B is replaced by a component 48D with a foot 48E in which is formed a hole 48F which is engageable with a hook-shaped formation 66A on the base. The actuator 53 has the nut 56 fixed to the member 46A and a leading end of the bolt 54 bears against a flat surface of the support 26.

Clearly, by rotating the actuator 53 the plate 40A and the locking member 46A can be moved apart so that the structure 32A is releasably, yet securely, fixed to the base 12A.

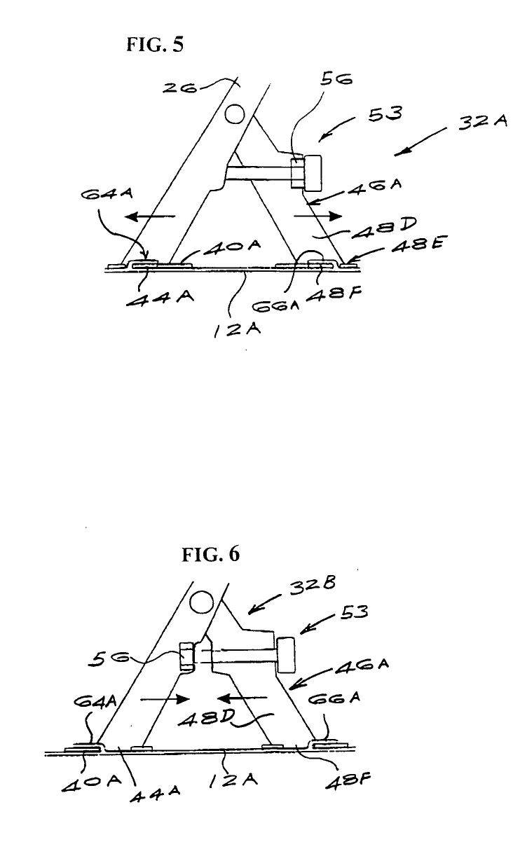

The arrangement in FIG. 6 is similar to the arrangement in FIG. 5 except that the orientations of the formations 64A and 66A are reversed. In contrast to the process adopted with the FIG. 5 arrangement the locking member 46A is moved towards (and not away from) the plate 40A to fix the structure 32B to the base 12A.

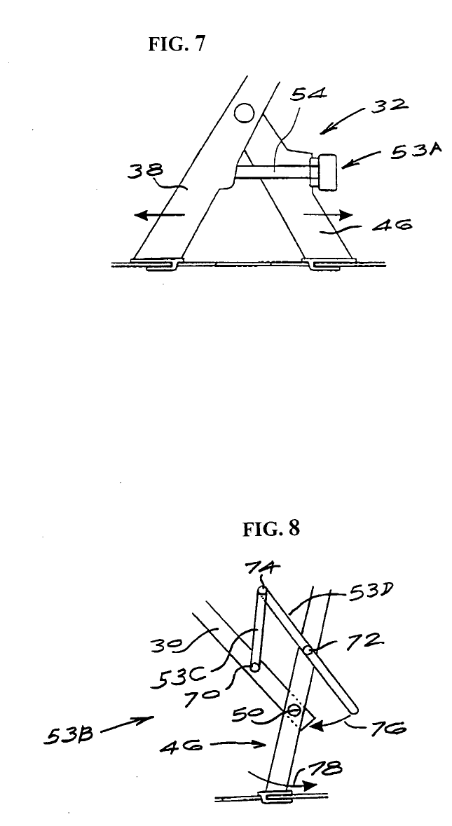

FIG. 7 shows structure 32 which is similar to that shown in FIG. 5 wherein the actuator designated 53A has a bolt 54 which is threadedly engaged with a nut 56A fixed to the locking member, and which bears against the webs 36 and 38. If the actuator is rotated in one direction the locking member and the plate 40 are moved apart, and are thereby securely fixed to the base, while counter-rotation of the actuator releases the seat arrangement from the base.

FIG. 8 shows an over-centre actuator 53B which replaces the screw device 53. The actuator 53B has two levers 53C and 53D respectively which are pivotally attached to the section 30 and the locking member 46 at points 70 and 72 respectively, and to each other at a point 74. If the lever 53C is pushed down, in the direction of an arrow 76, pressure is applied to the locking member, a lower end of which moves in a direction 78 into secure engagement with the base, while the section 30, and hence the plate 40, are moved in the opposite direction thereby to secure the seat arrangement to the base. The lever 53B, when moved to an over-centre position, locks in position yet is readily released, when required, by lifting the free end of the lever away from the section 30.

1. A scooter which includes a base, front and rear wheels near respective opposed ends of the base, an upwardly extending support, a seat at an upper end of the support, structure, at a lower end of the support, which includes at least first and second relatively movable formations which are respectively engageable with third and fourth formations on the base, and an actuator for causing relative movement of the first and second formations thereby to secure the structure to the base.

2. A scooter according to claim 1 wherein the first and second relatively movable formations are respectively first and second hook-shaped formations which are respectively engageable with the third and fourth formations on the base.

3. A scooter according to claim 2 wherein the third and fourth formations on the base are respective apertures with which the hook-shaped formations are respectively engageable.

4. A scooter according to claim 1 wherein the structure includes a locking member which is pivotally mounted to the support and which includes the first relatively movable formation, and a second member which includes the second relatively movable formation.

5. A scooter according to claim 4 wherein the actuator is operable to cause the locking member to pivot relatively to the support and to the second member.

6. A support according to claim 5 wherein the actuator includes a screw device which is threadedly engaged with at least one of the locking member and the support.

7. A scooter which includes a base, front and rear wheels near respective opposed ends of the base, an upwardly extending support, a seat at an upper end of the support, a load transferring structure, at a lower end of the support, which bears against an upper surface of the base, at least two spaced formations on the load transferring structure which are respectively engageable with two complementary formations on the base, a locking member which is mounted for movement relatively to the support and which has at least one formation which is engageable with a complementary formation on the base, and an actuator for causing movement of the locking member relatively to the support thereby to secure the locking member and the load transferring structure to the base.

8. A scooter according to claim 7 wherein the load transferring structure includes a plate which bears on the upper surface of the base and the two spaced formations are hook-shaped formations on the plate, and wherein the two complementary formations on the base are two respective apertures.

9. A scooter according to claim 7 wherein the actuator is a screw device which is rotatable to cause movement of the locking member relatively to the support.

10. A scooter which includes a base, front and rear wheels near respective opposed ends of the base, an upwardly extending support, a seat at an upper end of the support, two webs which are fixed to a lower end of the support, a plate which is fixed to the webs and which bears on an upper surface of the base, the plate having two spaced hook-shaped formations which are respectively engageable with apertures in the base, a locking member which is pivotally secured to the base and which is engageable with a complementary formation on the base, and an actuator which is operable to move the locking member relatively to the plate thereby to secure the plate and the locking member to the base.
